(19) United States
(12) Patent Application Publication
(10) Pub. No.: US 2008/0317933 A1
(43) Pub. Date: Dec. 25, 2008

(54) MILLING PROCESS FOR FINE GRINDING HIGH OIL CONTENT SEEDS

(75) Inventor: Michael Mark WILLIAMSON, Statesville, NC (US)

Correspondence Address: AMIN HALLIHAN, LLC, 444 NORTH ORLEANS STREET, SUITE 400, CHICAGO, IL, 60654, US

(73) Assignee: APOLONEX, LLC, Atlanta, GA (US)

(21) Appl. No.: 12/140,106

(22) Filed: Jun. 16, 2008

Related U.S. Application Data
(60) Provisional application No. 60/936,856, filed on Jun. 22, 2007.

(51) Int. Cl. A23L 1/36; B02C 4/08

(52) U.S. Cl. 426/629; 241/141; 241/143

(57) ABSTRACT

An apparatus for preparing a finely divided meal or flour product includes at least one pair of corrugated rolls, a first drive mechanism for rotating a first roll in a first direction at a first speed, and a second drive mechanism for counter-rotating a second roll in a second direction at a second slower speed. Each roll is provided with Twin City Chunk corrugations set in an outer surface of the rolls in a spiral pattern of about 1.5 inches per lineal foot. The difference in rotational speeds of the first and second rolls provides a reduction ratio of about 2:5.1. Finely divided meal or flour products and methods for producing the products using the disclosed apparatus are also provided.

This application claims the benefit of earlier filed U.S. Patent Application Ser. No. 60/936,856 filed on 22 Jun. 2007.

### FIELD OF THE INVENTION

The present invention relates to a method and apparatus for grinding high-oil content seeds and, more particularly, milling methods and apparatus for preparing a fine meal from small high-oil content seeds such as chia seeds.

### BACKGROUND

Physicians and researchers are increasingly studying nutrition and/or dietary intake of certain compounds, and the effects of these compounds, on various disease conditions. One family of compounds of particular interest is the essential fatty acids: omega-3 fatty acids which include alpha-linolenic acid (ALA), eicosapentaenoic acid (EPA), and docosahexanaenoic acid (DHA); and omega-6 fatty acids.

Clinical studies indicate that supplementing the diet with omega-3 fatty acids and/or increasing the daily consumption of omega-3 fatty acids may reduce the risk of certain diseases and/or alleviate symptoms associated with certain diseases such as, for example, coronary heart disease, rheumatoid arthritis, diabetes, neurological and/or behavioral disorders, and certain cancers.

Omega-3 fatty acids cannot be made by the human body and, therefore, must be obtained through a person's diet. Foods that are high in omega-3 fatty acids include fish, such as salmon, tuna, mackerel, lake trout, herring, sardines, swordfish, shark, halibut, krill, algae, some plants and plant seeds, and nuts and nut oils.

Plant seeds which have been found to be rich in oil containing omega-3 fatty acids, particularly ALA, include, for example: chia seed (Salvia hispanica); perilla seed (Actinidia chinensis), also known as shiso; flax seed (Linum usitatissimum), also known as linseed; kiwifruit seeds (Actinidia chinensis); and black raspberry seed (Rubus occidentalis). For example, chia seeds typically contain about 34% by weight oil, of which approximately 64% is comprised of ALA.

In addition to the high oil and omega-3 fatty acid content, many of these seeds, in particular chia and flax seeds, generally contain a high level of fiber that can be advantageously used to supplement the diet. For example, chia seeds typically contain about 25% by weight dietary fiber, which is mostly soluble fiber, and flax seeds typically contain about 28% by weight dietary fiber.

However, these high oil content seeds are generally of small size making them difficult to process. For example, chia seeds are typically small ovals having a diameter of about one (1) millimeter. Similarly, the flax plant produces a seed, shaped like an apple pip, that is about 4 to about 7 millimeters long.

Most oil seeds have a dense and/or relatively hard outer shell or seed coat that is essentially indigestible in the human gastro-intestinal system. Accordingly, such seeds may be milled or ground to provide a meal or flour-like product that can be more readily incorporated into food products and can generally be more easily digested.

However, due to the high oil content, milling of these seeds typically involves several steps wherein valuable nutrients and oil can be lost. Generally, to avoid oil build-up in milling equipment, high oil content seeds are first pressed to extract some of the oil. The pressed seeds can then be processed into a meal. Unfortunately, the pressing process greatly reduces the nutritional content of the product due to loss of desirable components such as, for example, omega-3 fatty acids in the expressed oil and/or fiber from the seed coat.

Thus, there is a need for a method of milling high oil content seeds that reduces the loss of nutritional components such as, for example, omega-3 fatty acids and/or dietary fiber from the finished product.

Other processes for preparing meals from high oil content seeds can include a cracking or cutting step wherein the seed coat is first broken and then the broken seed is further milled or refined to produce a meal. However, because the mechanical cracking releases some of the oil, the milling equipment can become fouled with expressed oil which can be transferred or released into the ground meal, thereby affecting the texture of the product and/or limiting the degree to which the particle size of the product can be reduced. Thus, such current milling practices can limit a manufacturer's ability to produce a finely divided particulate or flour product. Further, transfer of excess oil to the milled product can undesirably impact the texture of the product such as, for example, producing a gummy or pasty meal which can have a less desired mouth-feel to the consumer and/or be more difficult to incorporate into food products.

Accordingly, there is a need for a milling process that can produce a finely divided flour product from a high oil content seed such as, for example, chia seed, having a powdery and/or free-flowing texture. There is an additional need for a finely divided flour product that has a desired texture or mouth feel that can be readily incorporated into food and/or beverage products.

Finally, in many traditional processes, milling or grinding of the seeds produces excess heat, such as by friction of the seeds against the grinding rolls, that can result in loss of oil from the seeds, fouling of the milling equipment and/or products having reduced nutritional content. Further, such heat can oxidize components of the seed oils which can cause the product to develop an undesirable flavor and/or can cause or promote spoilage, i.e., the product may become rancid and inedible at a faster rate due to the initiation of oxidation of oil components during the milling process.

In view of the above, there is a need for a method of milling high oil content seeds which reduces or eliminates heat build-up in the milling equipment and, concomitantly, the transfer of oxidized oils to the milled seed products.

### SUMMARY OF THE INVENTION

A general object of the invention is to fine grind small seeds with a high oil content. A further objective of the invention is to provide a finely divided flour product derived from high oil content seeds such as, for example, chia seeds, having improved texture, nutritional value and/or stability. A still further objective of the present invention is to provide a meal or flour product having increased surface area for more efficient absorption of nutrients into the body.

A more specific object is to overcome one or more of the problems described above.

The general object of the invention can be obtained, at least in part, through an apparatus for milling high oil content seeds which includes or consists of a pair of counter-rotated, spirally corrugated rolls or cylinders to subject the seeds to a shearing or scissoring force thereby reducing the seeds to a finely divided flour without release of oil into corrugations on the rolls.

An apparatus for preparing a finely divided meal or flour product includes at least one pair of corrugated rolls, a first drive mechanism for rotating a first roll in a first direction at a first speed, and a second drive mechanism for counter-rotating a second roll in a second direction at a second slower speed. The first and second rolls are separated via a gap which can be adjusted by changing a position of the first and/or second roll. Each roll is provided with 28 Twin City Chunk corrugations set in an outer surface of the rolls in a spiral pattern of about 1.5 inches per lineal foot. The difference in rotational speeds of the first and second rolls provides a reduction ratio of about 2:5.1.

In another aspect, an apparatus for preparing a finely divided meal or flour product from high oil content seeds includes a first pair of corrugated rolls and a second pair of corrugated rolls, the second pair of corrugated rolls positioned adjacent to the first pair of corrugated rolls. Each of the rolls in provided with 28 Twin City Chunk corrugations per inch set into an outer surface of the rolls in a spiral pattern of about 1.5 inches per lineal foot. The first rolls of each pair of corrugated rolls are rotated in a first at a first speed and the second rolls of each pair of corrugated rolls are rotated at a second slower speed via a second drive mechanism. The first and second speeds are selected to provide a reduction ratio of about 2.5:1.

In a further aspect, the invention provides a finely divided meal or flour products from chia seeds (Salvia hispanica), perilla seeds (Actinidia chinensis), flax seed (Linum usitatissimum), kiwifruit seeds (Actinidia chinensis), and/or black raspberry seeds (Rubus occidentalis) and a method for preparing the meal or flour product.

The method includes delivering a quantity of high oil content seeds to a gap between a pair of counter-rotated, spirally corrugated rolls wherein the seeds are subjected to shearing and scissoring forces thereby reducing the seeds to a finely divided meal or flour product without substantial compression of the high oil content seeds. The finely divided meal or flour product is produced without pretreatment of the high oil content seeds and in a single milling step.

As used herein, the term “high oil content seeds” refers to seeds which contain or include greater than about 25% oil by weight and, in accordance with certain embodiments, seeds which contain or include greater than about 30% oil by weight. Examples of such high oil content seeds include, but are not limited to, chia seed (Salvia hispanica); perilla seed (Actinidia chinensis), also known as shiso; flax seed (Linum usitatissimum), also known as linseed; kiwifruit seeds (Actinidia chinensis); rapeseeds (Brassica napus), also known as oilseed; and black raspberry seed (Rubus occidentalis).

As used herein, the term “flour” refers to a finely divided particulate or powder product. The term flour further encompasses “meal” products which includes or contains the entire seed contents including the seed coat. Flour or meal products prepared or produced in accordance with the invention generally have an increased surface area when compared to meal products produced from high oil content seeds by other methods, processes or apparatus, particularly those which include pretreatment steps which include or involve pressing the seeds prior to grinding.

### BRIEF DESCRIPTION OF THE DRAWINGS

FIGS. 1A and 1B are front and side views, respectively, of a roller mill apparatus suitable for use in the practice of the present invention.

FIGS. 2A and 2B are a plan view and an end view, respectively, of a pair of rolls suitable for use in the milling of high oil content seeds in accordance with the invention.

FIG. 3 is a section of a face of a roll showing ribs and grooves which constitute a roll dress suitable for use in the milling of high oil content seeds in accordance with the present invention.

FIGS. 4A and 4B are diagrams showing the drive pulley configurations corresponding to the left and right sides, respectively, of a roller mill including two pairs of grinding cylinders or rolls.

### DETAILED DESCRIPTION

The invention provides an apparatus and a method for preparing, in a single pass, a finely divided particulate product from a high oil content seed. In particular, the invention contemplates a milling process to prepare flour having an improved nutritional profile, a desired texture and/or improved shelf life.

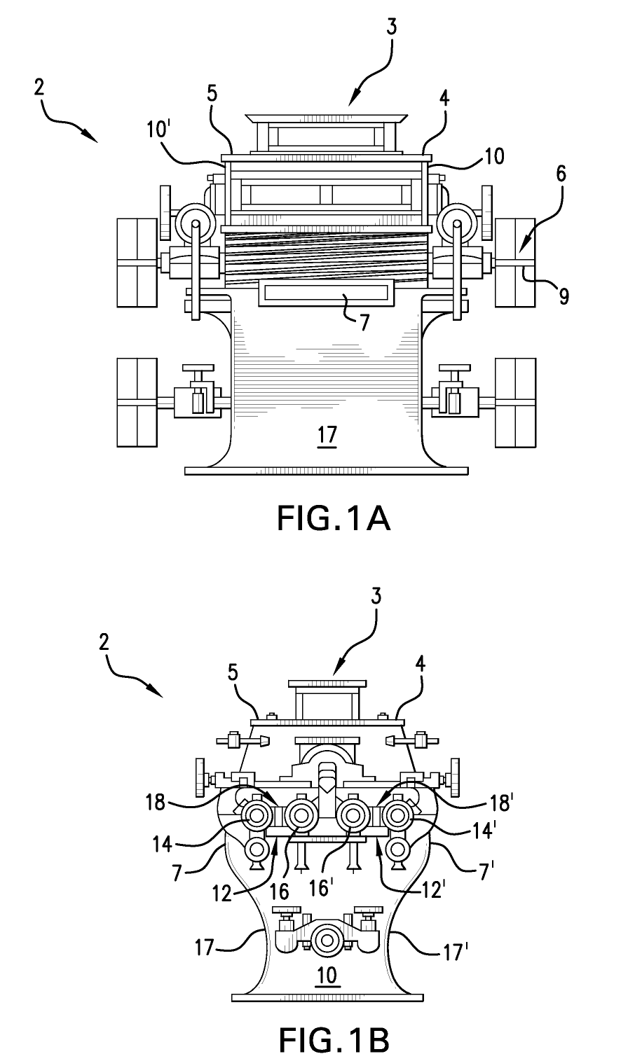

An apparatus for milling high oil content seeds can be in the form of a roller mill 2, as shown in FIG. 1A, which includes at least one pair of rolls or cylinders 12 positioned in a horizontal plane. Suitably, the rolls 12 are configured and operated in a manner such that high oil content seeds can be reduced to a finely divided meal or flour product in a single pass, i.e., without the use of one or more pretreatment and/or grinding steps.

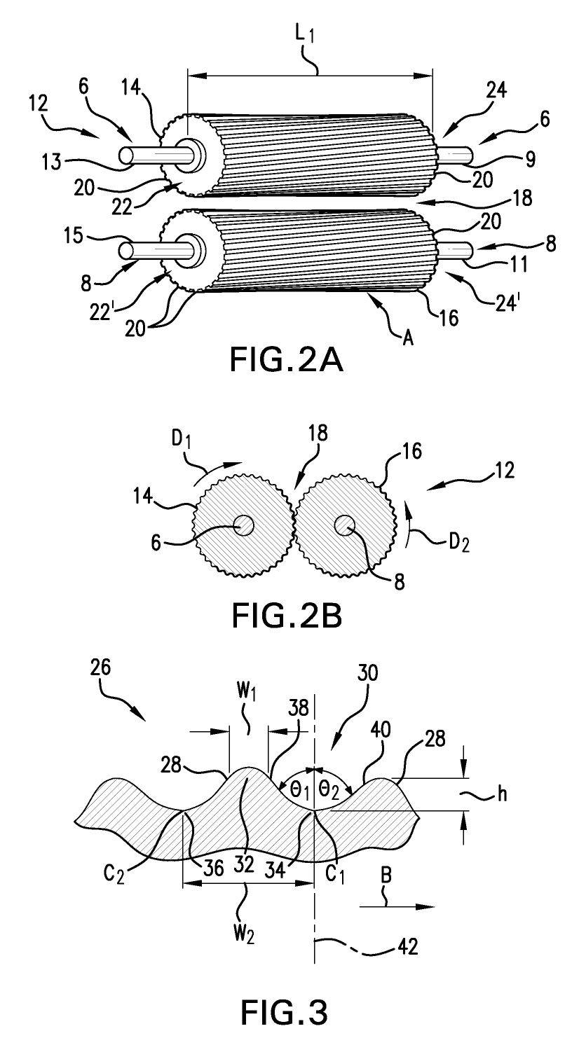

In accordance with certain embodiments, such as shown in FIG. 1B, a roller mill 2 can include two pairs, or a total of four, rolls, 12 and 12′, disposed in a horizontal plane. In accordance with certain embodiments, each roll can have a diameter of about nine (9) inches (about 22.9 cm) and a length of about 36 inches (about 91.4 cm). Suitably, the rolls 12 are made or formed from a hard, durable material such as, for example, spun cast steel. As shown in FIGS. 2A and 2B, each pair of rolls, 12 and 12′, includes a first roll 14 separated from a second roll 16 by a gap or nip 18. In practice, a quantity of high oil content seeds can be fed to the gap 18 between the first and second rolls, 14 and 16, wherein the seeds are subjected to a shearing of scissoring force that reduces the seeds into a particulate product such as, for example, a finely divided flour product and/or a coarser meal product.

Referring to FIGS. 1A, 1B, 2A and 2B, the first roll 14 further includes and is rotatably mounted on a first shaft 6 and the second roll 16 further includes and is rotatably mounted on a second shaft 8. In practice, the first and second rolls, 14 and 16, are mounted within a housing 4 of the roller mill 2 such that portions of opposing ends of the first and second shafts, 6 and 8, extend through side walls, 10 and 10′, of the housing 4. For example, as shown in FIG. 1A, a first end portion 9 of the first shaft 6 of the first roll 14 and a first end portion 11 of the second shaft 8 of the second roll (not shown) extend through side wall 10 of the housing 4. Likewise, opposing second ends portions, 13 and 15, of the first and second shafts, 6 and 8, extend through side wall 10′ (not shown). In practice, one or more drive pulleys are operably connected to the first and second shafts, 6 and 8, via any suitable means which allows the first and second rolls, 14 and 16, to rotate freely about their respectively longitudinal axes.

In accordance with the invention, the first roll 14 rotates in a first direction (D₁) while the second roll 16 rotates in a second opposite direction (D₂). Advantageously, the first and second rolls, 14 and 16, are driven, such as via drive pulleys or belts, in a manner that pulls high oil content seeds into the gap 18 where the seeds are reduced to a finely divided meal or flour product.

For example, as shown in FIGS. 1A and 1B, high oil content seeds can be fed from a hopper or opening 3 disposed in an upper surface 5 of the housing 4 of the roller mill 2 into the gap 18 between the first and second rolls, 14 and 16. The reduced seed product such as in the form of a finely divided meal or flour product can be collected from the gap 18 such as, for example, via a chute or opening 7 disposed below the pair of rolls 12 and, as shown in FIG. 1A, provided in a front wall 9 of the housing 4. In roller mills which employ two pairs of rolls 12 and 12′, in the same horizontal plane, as shown in FIG. 1B, chutes or openings, 7 and 7′, can be provided in both the front wall 9 of the housing 4 and the back wall 9′ of the housing 4.

In accordance with certain embodiments, one or more fiber brushes (not shown) can be positioned beneath the first and second rolls, 14 and 16, within the housing 4 to remove and/or facilitate collection of the reduced seed product. Such brushes can be held in a tensioned state such as via weights or other suitable mechanism which allow the brushes to remain in contact with the rotating rolls, 14 and 16.

Suitably, a distance between the first roll 14 and the second roll 16, i.e., the gap 18, can be varied to adjust a texture of a milled product. For example, a narrower gap 18 can be utilized to provide a fine grind such as, for example, a finely divided meal or flour product while a wider gap 18 can be utilized to provide a coarser grind such as, for example, a meal product having a larger particle size.

In accordance with certain embodiments, the gap or nip 18 between the first and second rolls, 14 and 16, can measure about 0.005 inches to about 0.007 inches (about 0.0127 cm to about 0.0178 cm).

Each roll of the pair of rolls 12 is provided with a plurality of corrugations 20 which facilitate grinding or milling of the high oil content seeds. Suitably, as shown in FIG. 2A, the plurality of corrugations 20 are cut into an outer surface or face of the rolls, 14 and 16, in a parallel pattern which extends along a length (L₁) of each roll from a first end, 22 and 22′, respectively, to a second end, 24 and 24′, respectively. The corrugations 20 in the face of the rolls allow the roller mill to act much like a giant shears, or scissors, cutting the seed into a fine meal or flour product.

Generally, roller mills accomplish size reduction of grain and/or seeds through a combination of forces and design features. If the rolls rotate at the same speed, compression is the primary force used. If the rolls rotate at different speeds, shearing and compression are the primary forces. If the rolls are grooved or corrugated a tearing or grinding component is introduced. Typically coarse grooves provide less size reduction than fine grooves do.

Advantageously, the plurality of corrugations 20 is provided on the surface of the rolls, 14 and 16, in a manner which reduces or minimizes the amount of compression forces applied to the high oil content seeds. In general, when attempting to grind small seeds having a high oil content using traditional roller mill configurations, compression forces applied to seeds can result in the expression or loss of oil from the seeds. Such expressed oil can undesirably fill the grooves of the corrugations effectively rendering the machine useless for preparing a finely divided meal or flour product.

Suitably, the plurality of corrugations 20 is further provided on the surface of the rolls, 14 and 16, in a manner which reduces or minimizes the duration and/or frequency of contact of the corrugations with the high oil content seeds. In traditional milling processes which use steel rollers or cylinders to grind grains at high speed, a great deal of heat is generated, causing nutrients to be destroyed. Such heating of the rolls and/or gap 18, such as, for example, due to friction between the seeds and the corrugations 20, can cause or contribute to the deposition of oil from the seeds onto the surfaces of the rolls, particularly within the grooves of the corrugations 20. As discussed above, thermal build-up on the roll surfaces and/or within the gap 18 can also result in loss of oil and nutrients from the seeds, fouling of the milling equipment, reduced stability of the finished product due to oxidation of components of the oil, and/or undesirable textures.

In order to overcome one or more of the above problems, the plurality of corrugations 20 are provide or set into the outer surface of the rolls, 14 and 16, in a spiral or angled pattern which extends from the first end, 22 and 22′, of the rolls, 14 and 16, to the second end, 24 and 24′, of the rolls, 14 and 16.

In accordance with one embodiment, the corrugation 20 can be provided or cut into an outer surface of the rolls, 14 and 16, in a parallel, spiral pattern (A) of about 1.5 inches per lineal foot (about 3.81 cm per 0.304 lineal meter) from the first ends, 22 and 22′, of the rolls, 14 and 16, to the second ends, 24 and 24′, of the rolls. Such spiral corrugation pattern is about 3 times more severe than the 0.5 inch per lineal foot spiral corrugation pattern used in most tradition milling processes.

In practice, the spiral pattern (A) of the present invention has been found to improve the scissor action of the rolls, 14 and 16, thereby providing a finely divided meal or flour product having improved consistency and texture. For example, it has been found that by utilizing the spiral pattern (A) of the invention in combination with a select speed reduction ratio and/or a select corrugation configuration, described in greater detail below, a meal or flour product having a salt and/or pepper like consistency or texture can be produced from high oil content seeds.

Individual corrugations 20 can have any suitable form or configuration which maximizes the reduction of the high oil content seeds to a finely divided flour or coarser meal product while reducing the build-up of thermal energy on the roll surfaces and/or width in the gap 18. Generally, corrugation of the rolls, 14 and 16, introduce a grinding or tearing component into the milling process. It has been found that when milling high oil content seeds using traditional corrugation configurations such as grinding or tearing forces can enhance and/or facilitate the deposition of oil into the corrugations in an undesirable manner and can result in a product having an inconsistent texture or consistency, such as, for example, a gummy or pasty consistency which can undesirably alter the flavor and/or mouth feel of the end product and/or can limit the potential uses of the milled product. Accordingly, a corrugation configuration has been developed which enhances the shearing or scissor-like forces while minimizing or reducing the grinding and tearing forces, i.e., the corrugation configuration has been developed such that the high oil content seeds have minimal contact with the corrugations 20.

Traditionally, the corrugations are provided on the grinding rolls in a manner that allows the corrugations to pass in a dull-to-dull orientation when the rolls are rotated in opposite directions. Such dull-to-dull orientation is typically employed to reduce oil build-up within the grooves of the corrugations and to minimize fouling of the equipment and/or milled product. In accordance with present invention, a corrugation configuration has been further developed such that corrugations of the opposing grinding or milling rolls can be run in any orientation, e.g., dull-to-dull, dull-to-sharp, or sharp-to-sharp, without significant build-up of heat or oil within the grooves of the corrugations.

One such suitable configuration of the corrugations 20 is generally known as a Twin City Chunk (TCC) configuration. As shown in FIG. 3, such Twin City Chunk configuration 26 generally includes ribs 28 separated by grooves 30.

In accordance with one embodiment, the rolls, 14 and 16, can include twenty-eight grooves 30 per inch (about 28 grooves per 2.5 cm), i.e. a 28 TCC configuration. The ribs 28 can have a generally beveled configuration with a land 32 having a width (W₁) of about 0.014 inch (about 0.036 cm). Suitably, the individual ribs 28 have an overall width (W₂) of about 0.0357 inch (about 0.091 cm) as measured from a center point (C₁) of a first groove 34 to a center point (C₂) of an adjacent groove 36. Suitably, as shown in FIG. 3, the ribs 28 of a 28 TCC configuration 26 can have a height (h) of about 0.042 inch (about 0.107 cm).

The grooves 30 can be symmetrical or asymmetrical. For example, referring to FIG. 3, a groove 34 having a symmetrical configuration traveling in a direction (B) includes a leading edge 38 oriented at a first angle, Θ₁, as measured from a vertical centerline 42, and a trailing edge 40 oriented at a second angle, Θ₂, as measured from the center line 42, wherein Θ₁=Θ₂.

Advantageously, however, the grooves 30 can have an asymmetrical configuration wherein a leading edge of the groove is oriented at a greater angle for vertical than the trailing edge of the groove. For example, a corrugation 20 having a 28 TCC configuration 26 and traveling in direction (B), as shown in FIG. 3, can have a leading edge 38 of a groove 34 oriented at a first angle, Θ₁, of about 65° while a trailing edge 40 of the groove 34 can be oriented at a second angle, Θ₂, of about 40°.

In accordance with a further embodiment, the rolls, 14 and 16, can be provided with a plurality of corrugations 20 having a twenty-four Twins City Chunk (24 TCC) configuration wherein the face or outer surface of the rolls includes 24 grooves 30 per inch (about 24 grooves per 2.54 cm). Advantageously, the ribs 28 of the 24 TCC configuration can have: a land width (W₁) of about 0.0039 inch (about 0.0099 cm); an overall width (W₂) of about 0.0357 inch (about 0.091 cm); and a height (h) of about 0.0197 inch (about 0.050 cm). The grooves 30 can have an asymmetrical configuration wherein in a leading edge 38 of the groove 30 can be oriented at a first angle, Θ₁, of about 65° and a trailing edge 40 of the groove 30 can be oriented at a second angle, Θ₂, of about 40°.

In practice, it has been discovered that such spiral arrangement and Twin City Chunk configuration, as described above, of the corrugations 20 reduces or minimizes compression and/or frictional forces applied to the high oil content seeds, thereby allowing the production of a finely divided meal or flour product without significant deposition of oil into the corrugations 20. It has been further discovered that such arrangement and configuration of the corrugations 20 effectively reduces and/or eliminates thermal build-up on the surfaces of the rolls, 14 and 16, and within the gap 18.

Further, in accordance with the invention, the first and second rolls, 14 and 16, are rotated at a specific reduction ratio. In particular, the first roll 14 is rotated a first speed while the second roll 16 is rotated at a second, slower speed. For example, in accordance with certain embodiments, the first or fast roll 14 can be rotated at a speed of about 562.5 rpm while the second or slow roll 16 can be rotated at a speed of about 225 rpm.

Suitably, the reduction ratio, or difference in the cylinder speeds between the first and second rolls, is in a range of about 2.4:1 to about 2.6:1. In accordance with certain embodiments, the cylinder speeds of the first and second rolls, 14 and 16, are established to advantageously provide a reduction ratio of about 2.5:1.

In practice, it has been found that a reduction ratio as low as 2.3:1 or a reduction ratio as high as 2.65:1, when used in combination with the above-described spiral corrugation arrangement and Twin City Chunk configuration, results in an undesirable level of oil build-up in the grooves 30 of the corrugations 20. However, it has been surprisingly discovered that when the first and second rolls, 14 and 16, are provided with the above-described spiral corrugation arrangement and Twin City Chunk configuration and are rotated at first and second speeds that provide a reduction ratio of about 2.5:1, the roller mill 2 can be advantageously utilized to grind small, high oil content seeds into a fine meal or flour product without the problems associated with oil build-up in the corrugations. Accordingly, this invention allows for the production of highly nutritious meals derived from high oil content seeds such as, but not limited to, chia, flax, and/or canola seeds.

In accordance with one embodiment of the invention, the roller mill 2, as shown in FIG. 1B, is a double roller mill which includes two pairs milling rolls 12 and 12′, disposed in a horizontal plane. Each roll is provided with identical spiral corrugation arrangements and Twin City Chunk configurations as described above. The first pair of rolls 12 include: a first or fast roll 14 rotatably mounted on a first shaft 6; and a second or slow roll 16 rotatably mounted on a second shaft 8. The second pair of rolls 12′ include: a third or fast roll 14′ rotatably mounted on a first shaft 6′; and a fourth or slow roll 16′ rotatably mounted on a second shaft 8′.

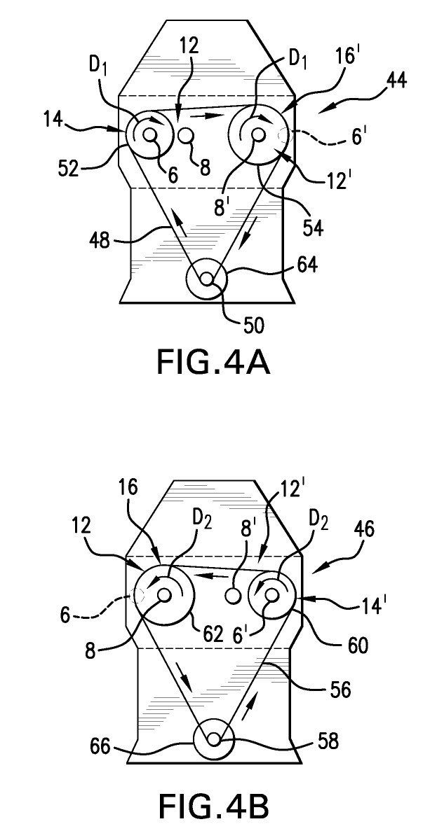

In practice, drive pulley configurations 44 and 46, shown in FIGS. 4A and 4B, respectively, can be used to provide the desired reduction ratio in the double roller mill 2. For example, referring to FIG. 4A, the first or fast roll 14 of the first pair of corrugated rolls 12 and the fourth or slow roll 16′ of the second pair of corrugated rolls 12′ can be driven using drive pulley configuration 44. In practice, a pulley, belt or other suitable drive means 48 runs in a continuous path: upwardly from a motor shaft 50 to a first sheave 52 mounted on first shaft 6 of the first roll 14; around the first sheave 52 to a second sheave 54 mounted on the second shaft 8′ of the fourth or slow roll 16′; around the second sheave 54, downwardly to and around the motor shaft 50. In this manner, the pulley configuration 44 rotates the first or fast roll 14 of the first pair of rolls 12 and the fourth or slow roll 16′ of the second pair of rolls 12′, in a first direction (D₁).

Referring to FIG. 4B, the third or fast roll 14′ of the second pair of rolls 12′ and the second or slow roll 16 of the first pair of rolls 12 can be driven using pulley configuration 46. In practice, a pulley, belt or other suitable drive means 56 runs in a continuous path: upwardly from a motor shaft 58 to a third sheave 60 mounted on the first shaft 6′ of the third or fast roll 14′; around the third sheave 60 to a fourth sheave 62 mounted the second shaft 8 of the second or slow roll 16; around the fourth sheave 62, downwardly to and around the motor shaft 58. In this manner the pulley configuration 46 counter-rotates the third or fast roll 14′ of the second pair of rolls 12′ and the second or slow roll 16 of the first pair of rolls 12 in a second and opposite direction (D₂).

In practice, it is contemplated that drive pulley configuration 44 can or could be provided on a first side of the roller mill 2, i.e., side 10 as shown in FIG. 1A, while drive pulley configuration 46 can or could be provided on a second opposite side of the roller mill 2, i.e. side 10′ as shown in FIG. 1A. It would, however, be within the scope of the present invention to provide both drive pulley configurations 44 and 46 on the same side of the roll mill 2 with suitable modifications to accommodate the various required shafts and drive mechanisms.

In accordance with certain embodiments, each of first shafts, 6 and 6′ as well as each of the second shafts, 8 and 8′, can have a diameter of about 18 inches (about 45.7 cm). Each of the motor shafts, 50 and 58, can be provided with a motor sheave, 64 and 66, respectively, having a diameter of about 5 inches (about 12.7 cm). Each of the first and third sheaves, 52 and 60, mounted on the first shafts, 6 and 6′, of the first and third rolls, 14 and 14′, i.e., the fast rolls, can have a diameter of about 8 inches (about 20.3 cm). Each of the second and fourth sheaves, 52 and 62, mounted on the second shafts, 8 and 8′, of the second and fourth rolls, 16 and 16′, i.e., the slow rolls, can have a diameter of about 20 inches (about 50.8 cm). In this manner, pulley configurations 44 and 46 can provide the desired reduction ratio of about 2.5:1.

In accordance with certain embodiments, a motor used to drive pulley configurations 44 and 46 can be a 20 horsepower motor which drives the motor shafts, 50 and 58, at a speed of about 900 rpm.

In another aspect, the present invention contemplates a method for producing meal or flour product from high oil content seeds having improved nutritional value, enhanced stability, and/or increased surface area compared to meal product produced from high oil content seeds using other methods.

A process for milling high oil content seeds in a single pass using the roller mill and rolls as described above, and in conjunction with FIGS. 1A, 1B, 2A, 2B and 3, includes: delivering a quantity of high oil content seeds into the gap 18 between the first and second rolls, 14 and 16; subjecting the seeds to shearing and/or scissoring forces, without substantial compression of the seeds, thereby reducing the seeds to a fine meal or flour product; and collecting the fine meal or flour product. The first and second rolls, 14 and 16, are provided with a 28 Twin City Chunk corrugation configuration set in a spiral pattern of about 1.5 inches per lineal foot in an outer surface of the rolls. The process further includes the steps of rotating the first roll 14 in a first direct (D₁) and at a first speed; counter-rotating the second roll 16 in an opposing direction (D₂) at a second speed, wherein the first speed is greater than the second speed. In accordance with certain embodiments, the first roll 14 and second roll 16 are counter-rotated at first and second speeds, respectively, to provide a reduction ratio of about 2.5:1.

The high oil content seeds can be selected from any plant source which produces a seed containing greater than about 25% by weight oil. Examples of high oil content seeds which can be milled in accordance with the processes and apparatus herein described include, but are not limited to, chia seed (Salvia hispanica); perilla seed (Actinidia chinensis), also known as shiso; flax seed (Linum usitatissimum), also known as linseed; kiwifruit seeds (Actinidia chinensis); and/or black raspberry seed (Rubus occidentalis). In accordance with certain embodiments, chia seeds can be milled to produce a finely divided meal or flour product having improved nutritional value, enhanced stability and/or increased surface area compared to meal product produced from chia seeds using other methods.

Although the invention has been described as particularly suitable for use in the milling of generally small size seeds, i.e., seeds having a diameter and/or length of less than about 7 millimeters, having a high oil content, it will be apparent to those skilled in the art that the apparatus and methods disclosed herein are amenable to modifications which can render the apparatus and methods suitable for milling seeds of a larger size and/or lower oil content.

While in the foregoing specification this invention has been described in relation to certain embodiments thereof, and many details have been put forth for the purpose of illustration, it will be apparent to those skilled in the art that the invention is susceptible to additional embodiments and that certain of the details described herein can be varied considerably without departing from the basic principles of the invention.

I claim:

1. An apparatus for milling high oil content seeds, comprising:
at least one pair of corrugated rolls, each pair of corrugated rolls including a first roll separated from a second roll by a gap for receiving the high oil content seeds, the first roll and the second roll each provided with 28 Twin City Chunk corrugations per inch set in an outer surface of the rolls in a spiral pattern of about 1.5 inches per lineal foot;
a first drive mechanism rotating the first roll of the at least one pair of corrugated rolls at a first speed in a first direction; and
a second drive mechanism counter-rotating the second roll of the at least one pair of corrugated rolls at second speed in a second direction, the first speed being faster than the second speed;
wherein a difference between the first speed and the second speed provides a reduction ratio of about 2.5:1.

2. The apparatus of claim 1, wherein the first and second rolls of the at least one pair of corrugated rolls are disposed within a common horizontal plane.

3. The apparatus of claim 1, comprising a first pair of corrugated rolls and a second pair of corrugated rolls disposed within a common horizontal plane.

4. The apparatus of claim 1, wherein the gap between the first and second rolls is in a range of about 0.005 inch to about 0.007 inch.

5. The apparatus of claim 1, wherein a position of at least one of the first roll and the second roll of each pair of corrugated rolls is adjustable to vary a width of the gap therebetween.

6. The apparatus of claim 1, wherein each Twin City Chunk corrugation includes a pair of beveled ribs separated by a groove, each rib having a land of about 0.014 inch, a rib width of about 0.0357 inch, a rib height of about 0.042 inch, a leading edge angle of about 65°, and a trailing edge angle of about 40°.

7. A method for producing a finely divided meal or flour product, comprising:
introducing a quantity of high oil content seeds into the apparatus of claim 1, the high oil content seeds delivered to the gap between the first and second rolls of the at least one pair of corrugated rolls;
subjecting the high oil content seeds to shearing and scissoring forces within the gap thereby reducing the seeds to a finely divided meal or flour product without substantial compression of the high oil content seeds; and
collecting the finely divided meal or flour product.

8. The method according to claim 7, wherein oil build-up in corrugations set into an outer surface of the first and second rolls is reduced.

9. The method according to claim 7, wherein the finely divided meal or flour product is produced from the high oil content seeds without pretreatment and in a single milling step.

10. An apparatus for milling high oil content seeds, comprising:
a first pair of corrugated rolls including a first roll separated from a second roll via a first gap, each of the first and second rolls provided with 28 Twin City Chunk corrugations per inch, the corrugations set into an outer surface of the first and second rolls in a spiral pattern of about 1.5 inches per lineal foot;
a second pair of corrugated rolls positioned adjacent to the first pair of corrugated rolls, the second pair of corrugated rolls including a third roll separated from a fourth roll via a second gap, each of the third and fourth rolls provided with 28 Twin City Chunk corrugations per inch, the corrugations set into an outer surface of the third and fourth rolls in a spiral pattern of about 1.5 inches per lineal foot;
a first drive mechanism rotating the first roll and the fourth roll of the in a first direction;
a second drive mechanism counter-rotating the second roll and the third roll in a second direction;
wherein the first and third rolls are rotated at a first speed, the second and fourth rolls are rotated at a second speed, and the first speed is faster than the second speed; and
wherein a difference between the first speed and the second speed provides a reduction ratio of about 2.5:1.

11. The apparatus of claim 10, wherein each Twin City Chunk corrugation includes a pair of beveled ribs separated by a groove, each rib having a land of about 0.014 inch, a rib width of about 0.0357 inch, a rib height of about 0.042 inch, a leading edge angle of about 65°, and a trailing edge angle of about 40°.

12. The apparatus of claim 10, wherein the first and second gaps have a dimension of about 0.005 inch to about 0.007 inch.

13. The apparatus of claim 10, wherein a distance defining the first gap is adjusted by changing a position of the first roll, changing a position of the second roll, or a combination thereof

14. The apparatus of claim 10, wherein a distance defining the second gap is adjusted by changing a position of the third roll, changing a position of the fourth roll, or a combination thereof

15. A finely divided meal or flour product derived from high oil content seeds and produced using the apparatus of claim 10.

16. The finely divided meal or flour product of claim 15, wherein the high oil content seeds are selected from the group consisting of chia seeds (Salvia hispanica), perilla seeds (Actinidia chinensis), flax seed (Linum usitatissimum), kiwifruit seeds (Actinidia chinensis), black raspberry seeds (Rubus occidentalis) and combinations thereof.

17. The finely divided meal or flour product of claim 15, comprising milled chia seeds.

18. An apparatus for milling high oil content seeds, comprising:
a first pair of corrugated rolls including a first roll separated from a second roll via an adjustable first gap, each of the first and second rolls provided with 28 Twin City Chunk corrugations per inch, the corrugations set into an outer surface of the first and second rolls in a spiral pattern of about 1.5 inches per lineal foot, the first roll rotatably mounted on a first shaft and the second roll rotatably mounted on a second shaft,
a second pair of corrugated rolls adjacent to the first pair of corrugated rolls, the second pair of corrugated rolls including a third roll separated from a fourth roll via a second adjustable gap, each of the third and fourth rolls provided with 28 Twin City Chunk corrugations per inch, the corrugations set into an outer surface of the first and second rolls in a spiral pattern of about 1.5 inches per lineal foot, the third roll rotatably mounted on a third shaft and the fourth roll rotatably mounted on a fourth shaft;
a first drive mechanism rotating the first roll and the fourth roll in a first direction;
a second drive mechanism counter-rotating the second roll and the third roll in a second direction;
wherein the first and third rolls rotate at a first speed, the second and fourth rolls rotate counter-rotate at a second slower speed, and a difference between the first speed and the second speed provides a reduction ratio of about 2.5:1;
wherein each the Twin City Chunk corrugations set into the outer surface of each roll of the first and second pairs of corrugated rolls includes a pair of beveled ribs separated by a groove, each rib having a land of about 0.014 inch, a rib width of about 0.0357 inch, a rib height of about 0.042 inch, a leading edge angle of about 65°, and a trailing edge angle of about 40°; and
wherein the high oil content seeds are selected from the group consisting of chia seeds (Salvia hispanica), perilla seeds (Actinidia chinensis), flax seed (Linum usitatissimum), kiwifruit seeds (Actinidia chinensis), black raspberry seed (Rubus occidentalis) and combinations thereof.

19. The apparatus of claim 18, wherein the first drive mechanism comprises a first drive belt running in a continuous path from a motor drive shaft upwardly to and around a first sheave mounted on the first shaft of the first roll of the first pair of corrugated rolls, from the first sheave to and around a second sheave mounted on the fourth shaft of the fourth roll of the second pair of corrugated rolls, and downwardly from the second sheave to and around the motor drive shaft.

20. The apparatus of claim 18, wherein the second drive mechanism comprises a second drive belt running in a continuous path from a motor drive shaft upwardly to and around a third sheave mounted on the third shaft of the third roll of the second pair of corrugated rolls, from the third sheave to and around a fourth sheave mounted on the second shaft of the second roll of the first pair of corrugated rolls, and downwardly from the fourth sheave to and around the motor drive shaft.
